(19) United States
(12) Patent Application Publication
(10) Pub. No.: US 2012/0316018 A1
(43) Pub. Date: Dec. 13, 2012

(54) Tensioner

(76) Inventors: Peter Ward, Farmington Hills, MI (US); Juergen Hallen, Aachen (DE)

(21) Appl. No.: 13/155,538

(22) Filed: Jun. 8, 2011

(51) Int. Cl. F16H 7/12

(52) U.S. Cl. 474/135

(57) ABSTRACT

A tensioner comprising a pulley, a base having a sleeve, an arm pivotally engaged with the base, the pulley journalled to the arm, a torsion spring connected between the arm and the base, an adjuster member rotatably engaged within a sleeve hole, a damping member fixedly connected to the arm, the damping member compressed between the arm and the base in an axial direction, the damping member having a frictional engagement with the base to damp an arm oscillation, and a retainer having an expandable member connectable to the adjuster, the expandable member engaged with a sleeve groove.

### FIELD OF THE INVENTION

The invention relates to a tensioner, and more particularly, a tensioner comprising a damping member fixedly connected to the arm, the damping member compressed between the arm and the base in an axial direction, the damping member having a frictional engagement with the base to damp an arm oscillation, and a retainer having an expandable member connected to the adjuster, the expandable member engaged with a sleeve groove.

### BACKGROUND OF THE INVENTION

The two most common means of transmitting power from a crankshaft for synchronously driving rotating members, such as cam shafts and balance shafts, are timing chains and belts. Timing chains require engine oil to operate. In comparison most timing belt applications require that no oil be present in the belt drive as the presence of oil can damage the belt and inhibit its intended purpose. Recent improvements in belts no longer require that a belt be sealed from the engine oil environment.

The recent improvement of belts to operate in oil, however poses other problems that need to be solved. One specific problem is properly tensioning the belt drive to keep the camshaft synchronized with the crankshaft. Should the camshaft or other synchronized driven crankshaft component no longer be properly synchronized with the crankshaft; catastrophic engine damage can result.

To transmit power through the belt from the rotating crankshaft one side of the belt is pulled around the crankshaft and is commonly referred to as the belt tight side by those skilled in the art. Conversely the other side is referred to as the belt slack side, since the belt is being pushed away from the crankshaft. It is important to provide tensioning to the slack side of the belt to prevent the belt from becoming unduly slack and thus causing a loss of synchronization between the crankshaft and the components rotated by the crankshaft. This loss of synchronization is commonly referred to as “tooth jump” or “ratcheting” by those skilled in the art.

Compounding the problem of eliminating belt slack to prevent “tooth jump” or “ratcheting” is excessive tensioner arm motion or vibration induced by the engine's angular vibration. Excessive arm motion could not only lead to a “tooth jump” or a “ratcheting” condition, but can also reduce the useful life of the tensioner and the belt as well. To minimize the amount of arm vibration; friction damping is commonly used to prevent the tensioner from moving away from the belt.

The presence of oil makes friction damping difficult to achieve. One can appreciate that the application of a lubricant to two rubbing surfaces will allow relative motion between the two surfaces to occur more easily.

The important aspect of friction damping is the resistant torque generated by friction damping to resist the motion of the arm away from the belt. It is desirable to only have asymmetric damping where the arm motion is resisted only when the tensioner moves away from the belt and not towards the belt as in the prior art for tensioners that operate in a dry environment.

Representative of the art is U.S. Pat. No. 5,919,107 which discloses a belt tensioner for tensioning a drive belt or timing belt comprises an eccentric adjusting member having an end surface thereof constructed and arranged to be mounted directly in surface-to-surface engagement with respect to a belt tensioner mounting surface for an engine frame. A pivoted structure is mounted on the eccentric adjusting member for pivoted movement between a first position and a second position, and a belt tensioning pulley is mounted for rotational movement on the pivoted structure. A coil torsion spring is constructed and arranged to resiliently bias the pivoted structure in a belt tightening direction away from the first position and toward the second position, the eccentric adjusting member being movable during an installation procedure to move the pivoted structure against the bias of the coil torsion spring into a position wherein the belt tensioning pulley is disposed in predetermined static tensioning relation with the belt, at which point the eccentric adjusting member is to be manually fixed. The end surface of the eccentric adjusting member is in sliding surface-to-surface relation with the mounting surface during rotation of the eccentric adjusting member.

What is needed is a tensioner comprising a damping member fixedly connected to the arm, the damping member compressed between the arm and the base in an axial direction, the damping member having a frictional engagement with the base to damp an arm oscillation, and a retainer having an expandable member connected to the adjuster, the expandable member engaged with a sleeve groove. The present invention meets this need.

### SUMMARY OF THE INVENTION

The primary aspect of the invention is to provide a tensioner comprising a damping member fixedly connected to the arm, the damping member compressed between the arm and the base in an axial direction, the damping member having a frictional engagement with the base to damp an arm oscillation, and a retainer having an expandable member connected to the adjuster, the expandable member engaged with a sleeve groove.

Other aspects of the invention will be pointed out or made obvious by the following description of the invention and the accompanying drawings.

The invention comprises a tensioner comprising a pulley, a base having a sleeve, an arm pivotally engaged with the base, the pulley journalled to the arm, a torsion spring connected between the arm and the base, an adjuster member rotatably engaged within a sleeve hole, a damping member fixedly connected to the arm, the damping member compressed between the arm and the base in an axial direction, the damping member having a frictional engagement with the base to damp an arm oscillation, and a retainer having an expandable member connectable to the adjuster, the expandable member engaged with a sleeve groove.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is an exploded view of the tensioner.

FIG. 2 is a cross-section of the tensioner.

FIG. 3 is an end perspective view of the adjuster and sleeve showing a retainer.

FIG. 4 is a cross section 4-4 of FIG. 3.

FIG. 5 is a perspective view of a retainer.

### DETAILED DESCRIPTION OF THE PREFERRED EMBODIMENT

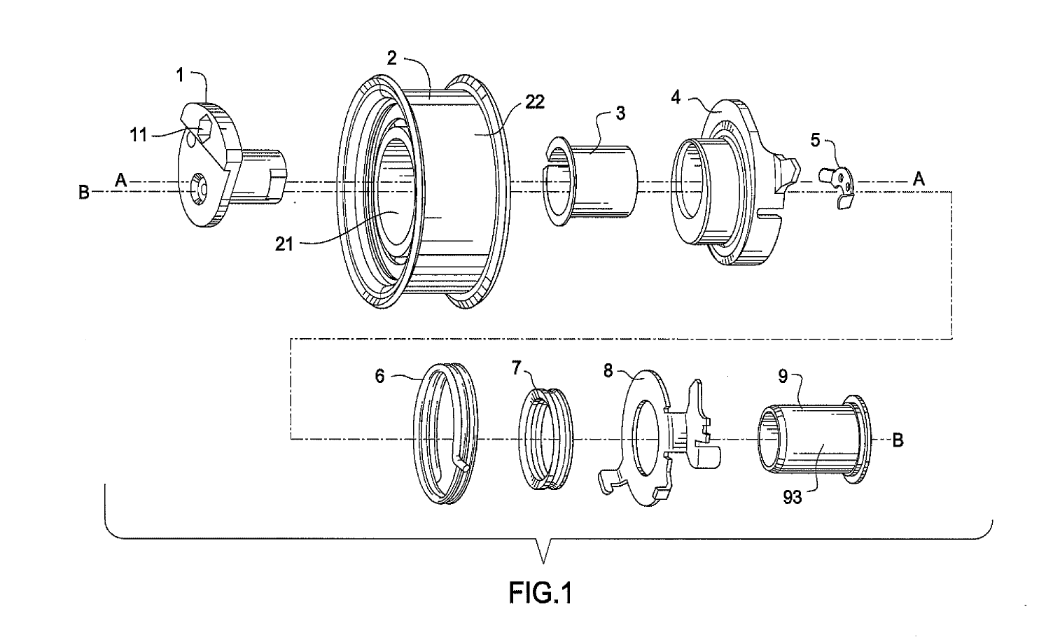

FIG. 1 is an exploded view of the tensioner. Pulley 2 engages a belt (not shown), for example on an engine accessory drive. Pulley 2 is journalled to an arm 4. Bearing 21 is disposed between pulley 2 and arm 4, thereby allowing pulley 2 to rotate about arm 4. Bearing 21 comprises a ball bearing as shown, but may also comprise a needle bearing or other suitable bearing known in the art.

Bushing 3 allows the arm 4 to smoothly rotate or pivot about sleeve 9. Sleeve 9 is rigidly connected to base 8. Bushing 3 creates some friction damping to prevent excessive movement of arm 4 that might otherwise be induced by an engine crankshaft angular vibration.

Arm 4 engages an inner race of bearing 21. The center of rotation for arm 4 about sleeve 9, axis A-A, is laterally offset from the center of rotation of pulley 2, axis B-B.

Arm 4 is urged against a belt by a torsion spring 6. Spring 6 is connected to base 8. Base 8 is statically connected to a mounting surface such as an engine using a fastener (not shown). The torque from spring 6 and the effective arm length of arm 4 is used to create belt load. The effective arm length of arm 4 is the distance between axis A-A and axis B-B.

A damping ring 7 creates friction damping between arm 4 and base 8. Damping ring 7 is press fit on arm 4 and therefore moves with arm 4 in a captive manner. Damping ring 7 is compressed in an axial direction between arm 4 and base 8. The axial direction is parallel to axis A-A. By being in a compressed state in this manner the arm is properly located and retained between the adjuster 1 and base 8.

The resistant frictional force or drag created by damping ring 7 rubbing against base 8, which base is statically fixed to the engine, damps oscillations thereby minimizing the amount of tensioner arm motion. This in turn minimizes “tooth jump” or “ratcheting” by a belt engaged with the pulley. The damping ring 7 may be used in an oil environment which may otherwise defeat frictional damping. This is due to the axial compression and the material used for the damping ring.

Damping ring 7 comprises any natural or synthetic rubber or any combination thereof including but not limited to EVA (ethylene vinyl acetate), ACSM (acsium alkylated chlorosulfonated polyethylene), EEA (Vamac, ethylene/acrylic), FKM (fluoro elastomers), CR (Neoprene or polychloroprene), ECO (epichlorohydrin ethylene oxide), NBR (nitrile), MQ (silicone rubber) FVMQ (flurosilicone rubber), CSM (chlorosulfonated polyethylene), CPE (chlorinated polyethylene), FFKM (perfluroelastomer), OT or EDT (polysulfide), AU (polyester), EV (polyether), urethanes, PZ (phosphazene). The material used for damping ring 7 allows the inventive tensioner to be used in an oil saturated environment, for example, under an engine timing cover.

Retainer 5 is used to retain or hold adjuster 1 in the assembly for shipping. Retainer 5 axially locks adjuster 1 to sleeve 9.

Adjuster 1 projects into sleeve 9 thereby capturing arm 4 between adjuster 1 and base 8. Adjuster 1 is eccentrically shaped because hole 12 is offset to one side of adjuster 1. Adjuster 1 is used to install the tensioner onto a mounting surface and thereby into a belt drive. A tool such as a wrench engages tool receiving portion 11. A fastener such as a bolt engages the hole 12 in adjuster 1.

During installation adjuster 1 is rotated to laterally translate the tensioner in the belt drive which has the effect of loading the tensioner against the belt to establish a predetermined tension in the belt. Adjuster 1 is then locked in place with a bolt, a nut, or another suitable fastener known in the art.

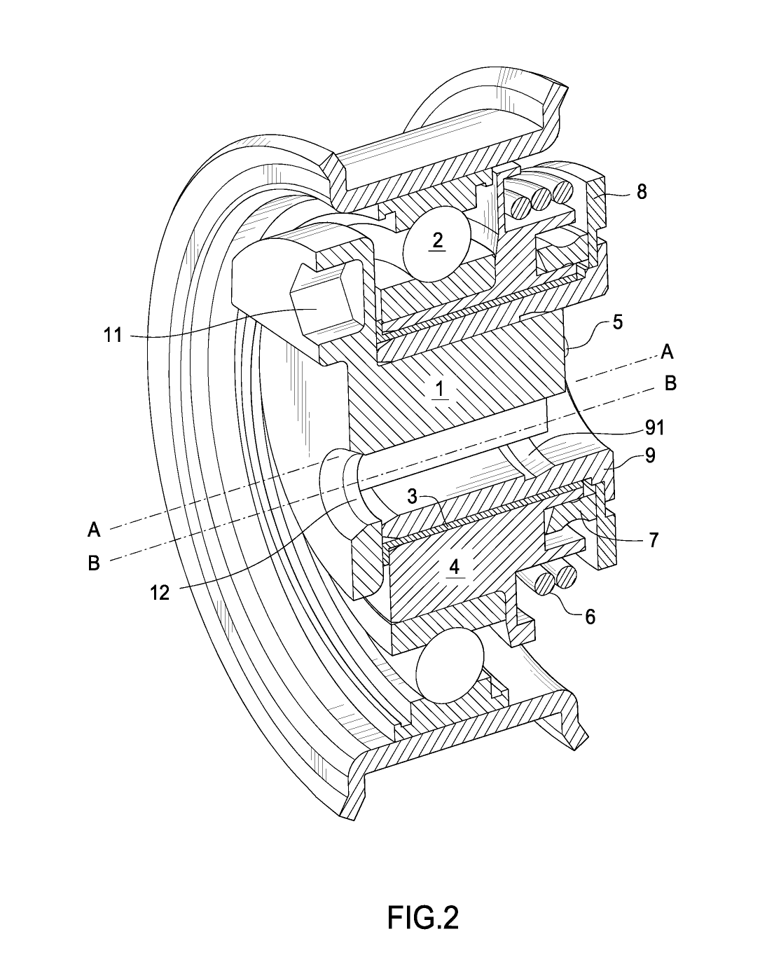

FIG. 2 is a cross-section of the tensioner. Hole 12 is offset to one side of adjuster 1. The center of rotation for pulley 2 is axis B-B. The center of rotation of arm 4 is axis A-A.

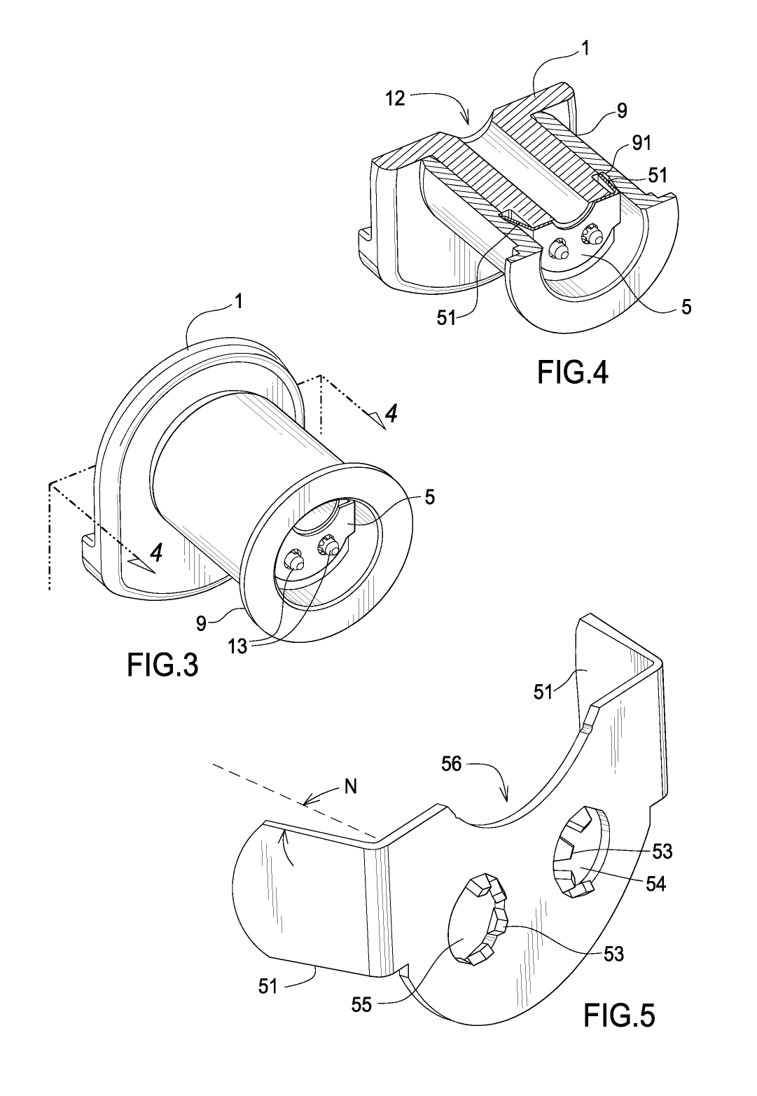

FIG. 3 is an end perspective view of the adjuster and sleeve showing a retainer. Retainer 5 is connected to an end of adjuster 1. Tangs 53 are bent slightly inward about the perimeter of a hole 54, 55. Tangs 53 grip each tab 13 extending from a base of adjuster 1.

FIG. 4 is a cross section 4-4 of FIG. 3. Each extending member 51, 52 is spring loaded and is disposed radially outwardly from the adjuster body. During installation, each member 51, 52 is pressed inward toward adjuster 1 by sleeve 9 as adjuster 1 is inserted into hole 12 in sleeve 9. Once adjuster 1 is fully inserted, since each member 51, 52 is biased radially outward, each deploys outwardly to engage groove 91. Once outwardly deployed each member 51, 52 prevents adjuster 1 from being extracted from sleeve 9, thereby effecting a mechanical connection between adjuster 1 and sleeve 9, which in turn holds the tensioner components together. Namely, adjuster 1 holds bearing 2 and arm 4 in pressing contact with base 8, and damping ring 7 is held in pressing contact with base 8 by arm 4.

However, groove 91 is continuous about the inner circumference of the sleeve, and so adjuster 1 can still be rotated within sleeve 9 even when each member 51, 52 is engaged with groove 91.

FIG. 5 is a perspective view of a retainer. An arcuate cut 56 allows clearance for a fastener such as a bolt to be inserted through hole 12.

Although a form of the invention has been described herein, it will be obvious to those skilled in the art that variations may be made in the construction and relation of parts without departing from the spirit and scope of the invention described herein.

We claim:

1. A tensioner comprising:
a pulley;
a base having a sleeve;
an arm pivotally engaged with the base;
the pulley journalled to the arm;
a torsion spring connected between the arm and the base;
an adjuster member rotatably engaged within a sleeve hole;
a damping member fixedly connected to the arm, the damping member compressed between the arm and the base in an axial direction, the damping member having a frictional engagement with the base to damp an arm oscillation; and
a retainer having an expandable member connectable to the adjuster, the expandable member engaged with a sleeve groove.

2. The tensioner as in claim 1, wherein the retainer comprises two or more expandable members which are normally disposed in a radially outward position with respect to a normal extending from the retainer body.

3. The tensioner as in claim 1, wherein the sleeve groove is circumferentially continuous.

4. The tensioner as in claim 1, wherein the damping member is compressed by engagement of the retainer with the sleeve groove.

5. The tensioner as in claim 1, wherein the damping member comprises one of or any combination of a natural or synthetic rubber including but not limited to EVA (ethylene vinyl acetate), ACSM (acsium alkylated chlorosulfonated polyethylene), EEA (Vamac, ethylene/acrylic), FKM (fluoro elastomers), CR (Neoprene or polychioroprene), ECO (epichlorohydrin ethylene oxide), NBR (nitrile), MQ (silicone rubber) FVMQ (flurosilicone rubber), CSM (chlorosulfonated polyethylene), CPE (chlorinated polyethylene), FFKM (perfluroelastomer), OT or EDT (polysulfide), AU (polyester), EV (polyether), urethanes, PZ (phosphazene).

6. A tensioner comprising:
a pulley;
a base having a sleeve;
an arm moveably engaged with the base;
the pulley journalled to the arm;
a torsion spring connected between the arm and the base;
an adjuster member rotatably engaged within a sleeve hole;
a damping member fixedly connected to the arm, the damping member compressed between the arm and the base in an axial direction, the damping member having a frictional engagement with the base to damp an arm oscillation; and
a retainer comprising two or more expandable members which are biased in a radially outward position with respect to a normal (N) extending from the retainer body.
